(19) United States
(12) Patent Application Publication
(10) Pub. No.: US 2016/0318199 A1
(43) Pub. Date: Nov. 3, 2016

(54) ONE-PIECE, BLADELESS BOX OPENER

(71) Applicants: Perry Bruce Madaisky, Port Coquitlam (CA); John Emil Woochuk, Port Coquitlam (CA)

(72) Inventors: Perry Bruce Madaisky, Port Coquitlam (CA); John Emil Woochuk, Port Coquitlam (CA)

(21) Appl. No.: 14/698,796

(22) Filed: Apr. 28, 2015

(51) Int. Cl. B26B 27/00

(52) U.S. Cl. CPC B26B 27/005

(57) ABSTRACT

A plastic injection molded, one-piece, bladeless box opener which provides in a single device a configuration to safely facilitate the opening and/or deconstruction of taped, glued or stapled paperboard/cardboard boxes. Specifically, an ergonomic handle portion containing puncture points extending forward on the grip guard collar for puncturing heavy duty tape and; a wedge shaped elongated shaft portion to disengage any glued surfaces or flaps by inserting it, tip first, between two glued surfaces and given a slight twist and a tip portion. The shaft has tape splitting teeth located bilaterally on the edges and on the tip for ambidextrous use. Tape is split open by sliding the tape splitting teeth against a tape's edge. Box or Carton staples are removed by inserting the tip under the staple and twisting the hand left and right until the staple is freed.

### FIELD OF THE INVENTION

The present invention generally relates to a hand held box opening device for opening taped, glued or stapled boxes. More particularly, a safe alternative to conventional fixed or adjustable bladed utility knives, resulting in reduced injury claims and fewer incidences of damage to stock.

### BACKGROUND OF THE INVENTION

Most industries including, but not limited to, fulfillment, catalog, wholesalers, retail stores pharmaceutical industries and the public receive boxes through the mail, delivery services, and from stores. Boxes may be taped, glued or stapled shut and usually require a sharp object to cut the tape or the box to gain access to the contents.

Typically, cardboard containers are taped, glued or stapled shut with the majority being taped or glued.

When a taped cardboard container is to be opened, the carton is generally held steady in front of the operator with one hand while the other hand inserts the sharp blade of a slitting device between the surfaces taped together and then pulls the blade rapidly across the tape causing it to be cut.

When a glued or stapled cardboard container is to be opened it usually must be cut open. The carton is generally held steady in front of the operator with one hand and a slicing movement is made by the other hand by pulling the knife rapidly across the top or side of the container to obtain a clean, straight cut. Sharp blades are required for efficient opening of cartons, and a very sharp-edged blade is commonly used for that purpose.

People use a variety of sharp devices such as, and not limited to, razor blades, knives, utility knives, slitters and box cutters to open taped, glued or stapled boxes. This is particularly common in commercial settings.

Using these sharp devices to open boxes is potentially dangerous. Even with all the advancements to the conventional fixed or adjustable bladed utility knives, utility knife cuts still remain one of the leading causes of time lost in the workplace nationwide.

A significant problem with opening taped, glued or stapled boxes with sharp objects can be such use frequently involves quick hand movements and flesh wounds are likely to occur when the knife blade travels free at the end of a cut and catches the operator's hand, fingers, arm, waist or leg. This simple task has resulted in many on-the-job personal injuries and costly WCB claims.

Another problem when opening taped, glued or stapled boxes with sharp objects can result in damage to the product inside the box. This type of product damage is one of the leading causes of unsaleable merchandise. Even with improvements in packaging, shipping practices, warehouse design, and software, cutting the cost of unsaleable products is the constant challenge for those in the grocery industry. According to the June 2005 issue of Occupational Health, the Food Marketing Institute estimated that the grocery industry alone sustains nearly $20 billion annually in damaged merchandise. Of the $20 billion lost annually in the grocery industry alone, 30 percent was caused by careless box cutting. Product damage from box cutters translates into unsaleable goods. The high costs associated with product damage and returns is also an issue faced by most industries including, but not limited to, fulfillment, catalog, and pharmaceutical industries.

Another problem with opening glued or stapled boxes with sharp objects can result in damage to the carton itself. The top perimeter or side of the box needs to be cut to access the contents of the box, thus rendering the box useless for further use and more difficult to fit in with the environmentally sustainable strategy, being adopted by companies and municipalities everywhere, known as the 3R's—Reduce, Reuse, Recycle.

Another problem occurs when municipalities, commercial business, industry and citizens endeavor to reduce the amount of cardboard ending up in landfills and need to deconstruct cardboard boxes for the recycling process possibly cutting themselves using a sharp bladed object. At the residential level, children are commonly tasked with flattening the boxes.

There is need for an alternative safer tool for sharp slitting devices as referred to above, and in particular, there is need for a low cost device which can be utilized without danger, which could otherwise be presented by exposure to a sharp object.

The invention described herein is an alternative to sharp slitting/cutting devices, and in particular to hand-held box cutters/utility knives of the type used by, but not limited to, the public, stocking clerks and warehouse personnel to open cardboard cartons in, for example and not limited to, grocery stores, supermarkets, convenience stores, restaurants, other retail establishments, and Wholesaler distributors.

The invention described herein is a bladeless, molded plastic, one-piece box opener. The invention provides in a single device a configuration to safely and efficiently facilitate opening taped, glued or stapled boxes and also aids in their deconstruction, while addressing the problems of injuries and product damage associated with conventional apparatuses and methods for box opening and deconstruction.

The invention described herein has been developed with safety features which can be used safely even by untrained workers.

### BRIEF SUMMARY OF THE INVENTION

The present invention is a safe, plastic injection molded, one-piece, low cost and simple to use multi-use plastic box opener to facilitate in the opening and deconstruction of taped, glued or stapled paperboard/cardboard boxes.

Basically, the molded one-piece device comprises:

a. An ergonomic handle containing puncture points extending forward on the grip guard collar for puncturing tape,

b. A wedge shaped shaft portion to disengage any glued surfaces or flaps by inserting it, tip first, between two glued surfaces and also containing tape splitting teeth located on the tip end and bilaterally on the edges of the shaft for ambidextrous use, and

c. A thin flat staple removing tip which easily slides under staples.

The present invention has an ergonomic handle with a grip guard collar that can substantially reduce hand fatigue and stress during repetitive use.

The present invention has a tapered wedge shaped shaft that needs only to be inserted between two glued surfaces and given a slight twist to break a glue seal.

The present invention has a staple-removing tip that needs only to be inserted under a staple and given a slight left and right twisting motion to free the staple.

The present invention has tape splitting teeth on the shaft that need simply to be slid against a tape's edge to split the tape open.

The present invention has tape splitting teeth on the tip of the shaft that need simply be pushed against and through the tape, where the two surfaces are sealed, to split the tape open.

The present invention includes tape splitting teeth that are sharp enough to puncture and split open any tape used to tape a box shut; however, dull enough to substantially avoid puncturing or cutting a person's skin if the present invention comes into a forceful contact with a person's skin.

The present invention, having no sharp blades, will not cut or damage contents within the glued, taped, or stapled boxes.

The present invention can be made from either 100% post-consumer or 100% postindustrial waste recycled plastic and is 100% recyclable, making it virtually eternal.

The present invention can be made from any plastic resin which can be injection molded.

The present invention may be formed from several connected parts, but is preferably an integrally-molded, unitary article. The present invention may be injection molded in one-piece from moldable materials such as plastics. Moldable materials may include recyclable materials such as thermoplastics and may include at least in part recycled materials. Preferably, the box opener is formed entirely from recycled plastic.

The present invention is a safe tool to open glued, taped and stapled boxes, the three most common types of sealed boxes, and is an alternative to sharp slitting devices, and in particular to hand-held box cutters/utility knives.

### BRIEF DESCRIPTION OF THE DRAWINGS

FIG. 1 is a perspective top view of a box opener of the present invention;

FIG. 2 is a perspective bottom view of a box opener of the present invention;

FIG. 3 is a side view of a box opener of the present invention;

FIG. 4 is a perspective view showing a box opener of the present invention opening a box where the top flaps are glued shut;

FIG. 5 is a perspective view showing a box opener of the present invention opening a box where the top flaps are glued shut;

FIG. 6 is a perspective view showing a box opener of the present invention opening a box where the top flaps are glued shut;

FIG. 7 is a perspective view showing the open condition of a box after the top glued flaps were opened with a box opener of the present invention;

FIG. 8 is a perspective view showing a box opener of the present invention opening a box where the side flaps are glued shut;

FIG. 9 is a perspective view showing a box opener of the present invention opening a box where the side flaps are glued shut;

FIG. 10 is a perspective view showing the open condition of a box after the side-glued flaps were opened with a box opener of the present invention;

FIG. 11 is a perspective view showing a box opener of the present invention opening a box where the top flaps are taped shut;

FIG. 12 is a perspective view showing a box opener of the present invention opening a box where the top flaps are taped shut;

FIG. 13 is a perspective view showing a box opener of the present invention opening a box where the top flaps are taped shut;

FIG. 14 is a perspective view showing a box opener of the present invention opening a box where the top flaps are taped shut;

FIG. 15 is a perspective view showing the open condition of a box after the taped top flaps were opened with a box opener of the present invention;

FIG. 16 is a perspective view showing a box opener of the present invention opening a box where the top flaps are stapled shut;

FIG. 17 is a perspective view showing a box opener of the present invention opening a box where the top flaps are stapled shut;

FIG. 18 is a perspective view showing the open condition of a box after the staples were removed from top flaps with a box opener of the present invention;

FIG. 19 is a perspective view showing a box opener of the present invention being used to puncture tape on a fully tape sealed box, with a puncture point located on the grip guard collar, creating an access point for the shaft to enter;

FIG. 20 is a perspective close-up view showing the puncture point located on the grip guard collar of a box opener of the present invention puncturing tape on a fully tape sealed box top, creating an access point for the shaft to enter;

FIG. 21 is a perspective view showing the shaft of a box opener of the present invention inserted into the access point made by puncturing the tape using a puncture point located on the grip guard collar;

FIG. 22 is a perspective view showing a box opener of the present invention being used to puncture tape on a fully tape sealed box, with the tape splitter teeth located on the tip, creating an access point for the shaft to enter;

FIG. 23 is a perspective close-up view showing the tape splitter teeth located on the tip of a box opener of the present invention puncturing tape on a fully tape sealed box top, creating an access point for the shaft to enter;

FIG. 24 is a perspective view showing the shaft of a box opener of the present invention inserted into the access point made by puncturing the tape using the tape splitter teeth located on the tip.

### DETAILED DESCRIPTION OF THE INVENTION

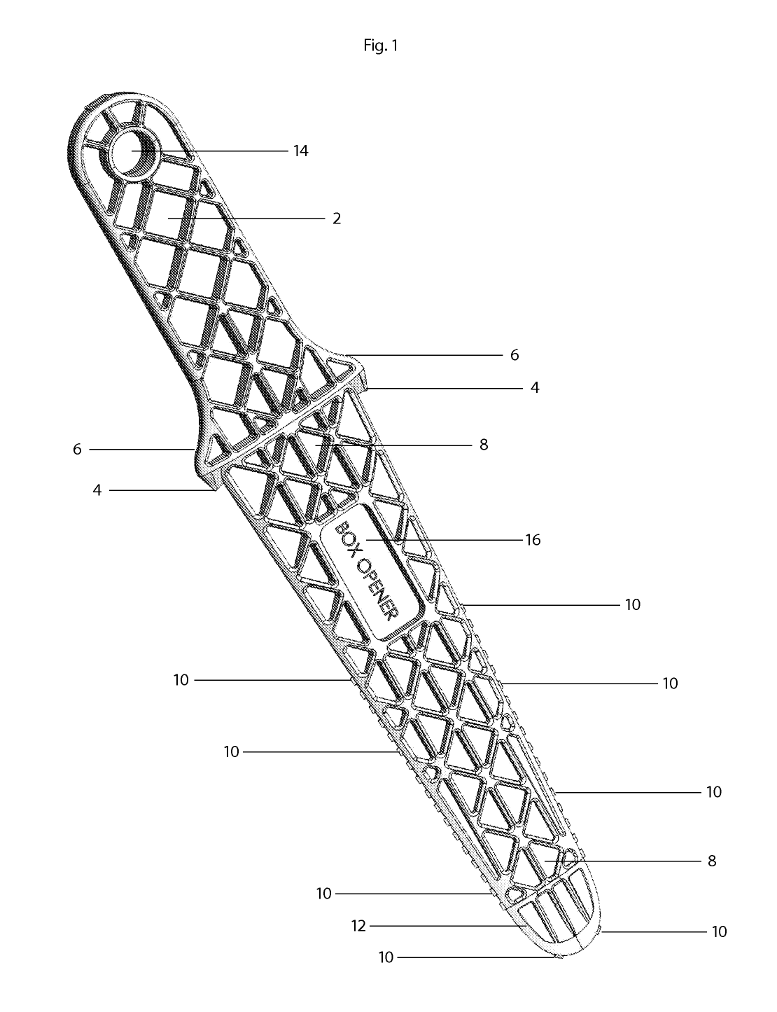

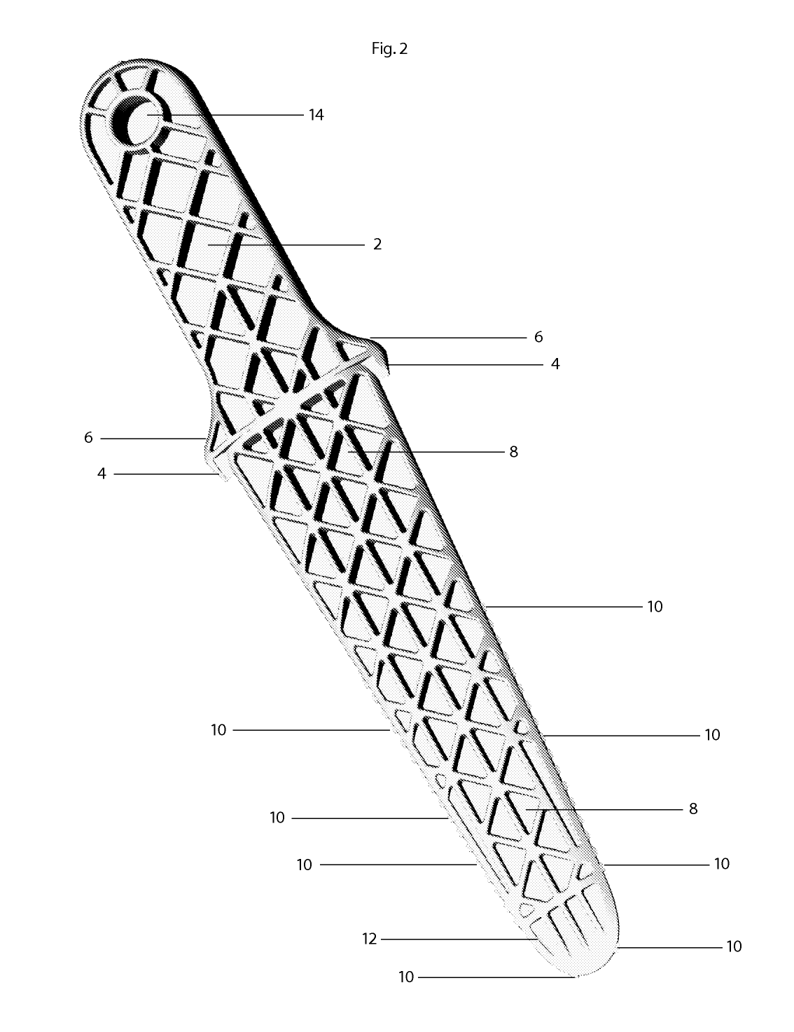

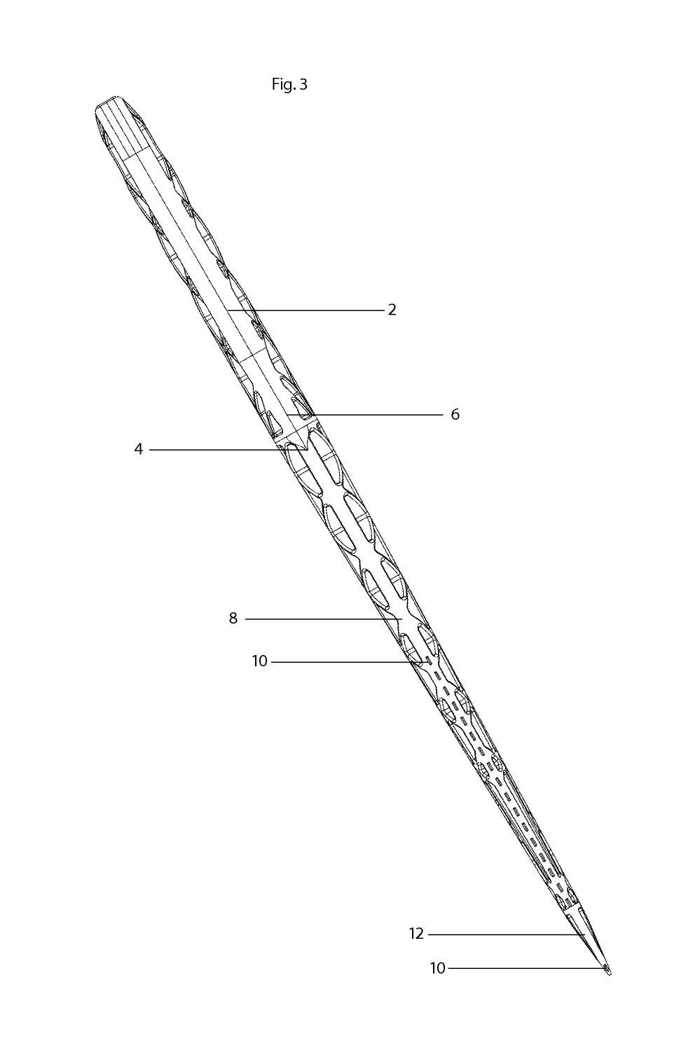

Referring now to the invention in more detail, in FIG. 1, FIG. 2 and FIG. 3 there is shown a one-piece bladeless box opener having a handle 2 containing puncture points 4 extending forward on the grip guard collar 6 and a wedge shaped elongated shaft 8 with tape splitting teeth 10 located bilaterally on the edges of the shaft 8 and on the tip end 12 of the shaft 8.

In further detail, still referring to the invention of FIG. 1 and FIG. 2, the handle 2 shows an optional hole 14 through the handle 2 for easy hanging onto, but not limited to, a nail or a hook.

In further detail, referring to the invention of FIG. 1, the shaft 8 shows an optional name plate/advertising space 16.

In further detail, referring to FIG. 3, the side view of the invention shows the wedge shaped shaft 8, a puncture point 4 extending forward from the grip guard collar 6 which is part of the handle 2 and some tape splitting teeth 10 on the edge and tip 12 of the shaft 8. The wedge shaped shaft 8 only needs to be inserted between two glued surfaces or flaps requiring separation to break the glued seal. If needed, the shaft 8 may be given a twist or an up and down prying action to break the glued seal. This action is repeated along the glued seal until a box with glued top flaps or a box with glued side flaps is fully opened.

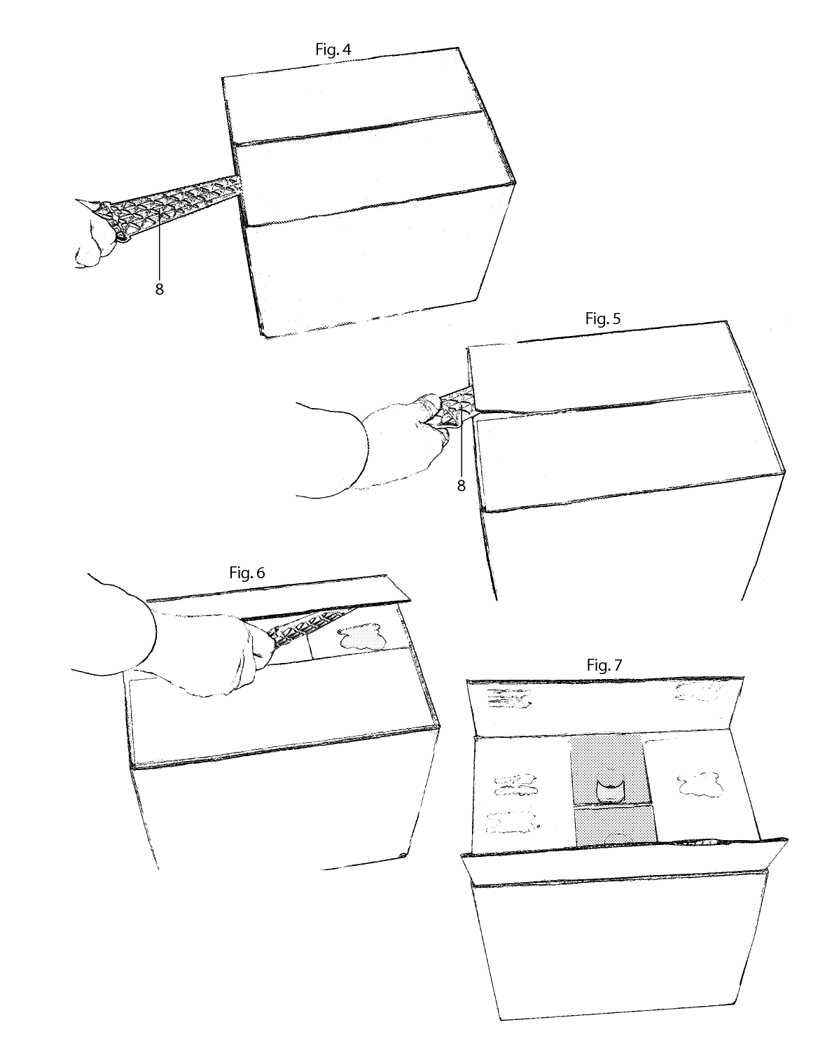

FIG. 4, FIG. 5 and FIG. 6 illustrate the manner the present invention may be used for opening a glued top flap box. FIG. 4 and Fig. .5 show the shaft 8 being inserted between one of the glued box top flaps and the surface to which it is glued to breaking the glued seal. FIG. 6 shows the present invention being given a twist, after the shaft was inserted between a glued top flap and the surface to which it was glued to, to complete the break. FIG. 7 shows the open condition of a box after the glued top flap seals were broken.

FIG. 8 and FIG. 9 illustrate the manner the present invention may be used for opening a glued side flap box. The shaft 8 is inserted between a side flap and the surface to which it is glued to, to break the glued seal and if needed given a slight twist to complete the break.

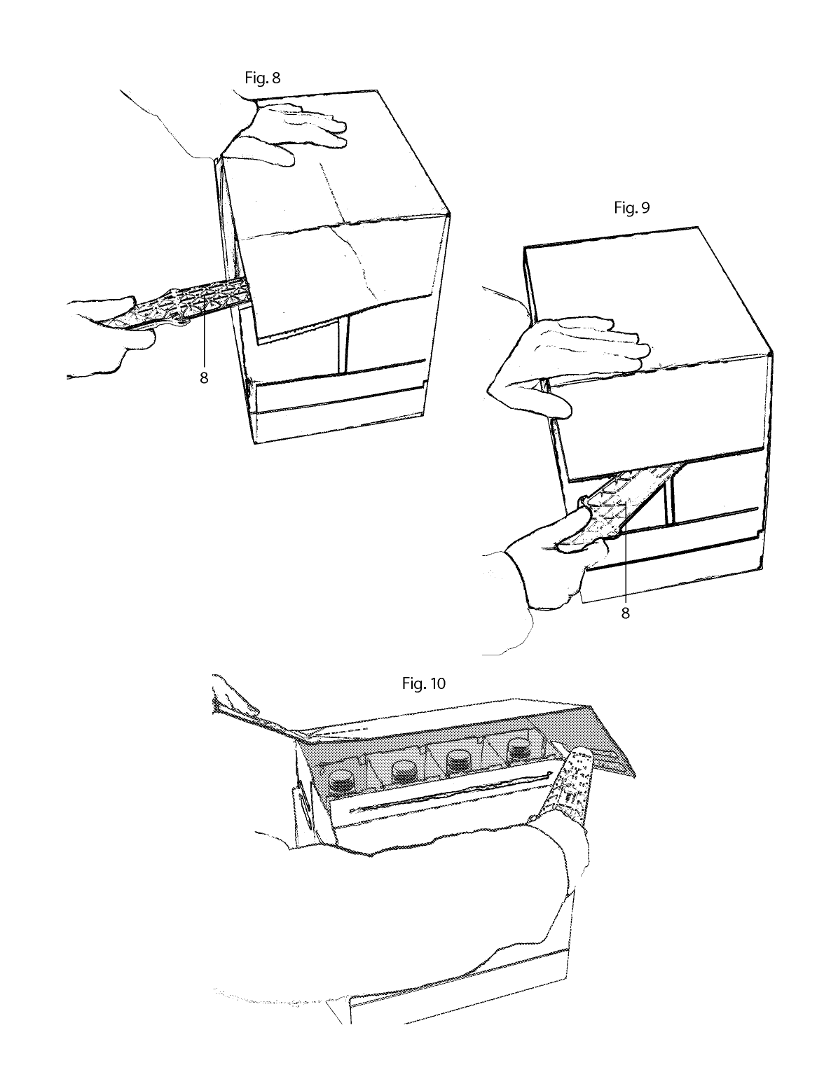

FIG. 10 shows the open condition of a box after the glued side flap seals were broken.

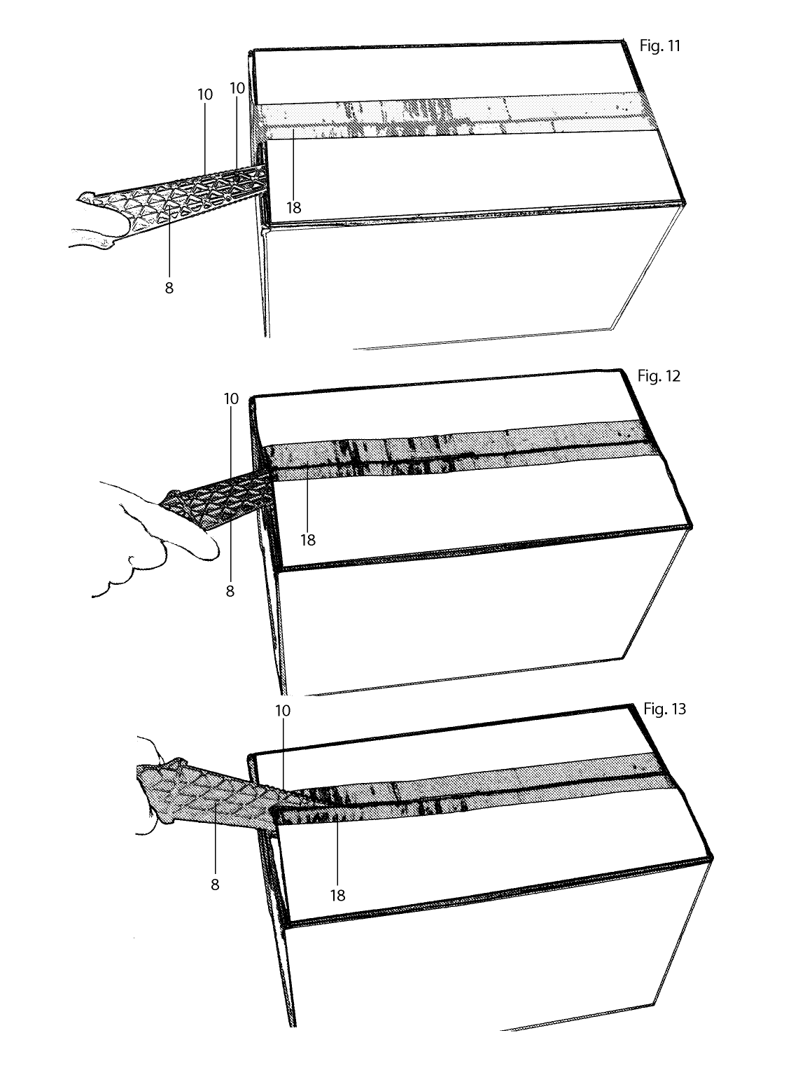

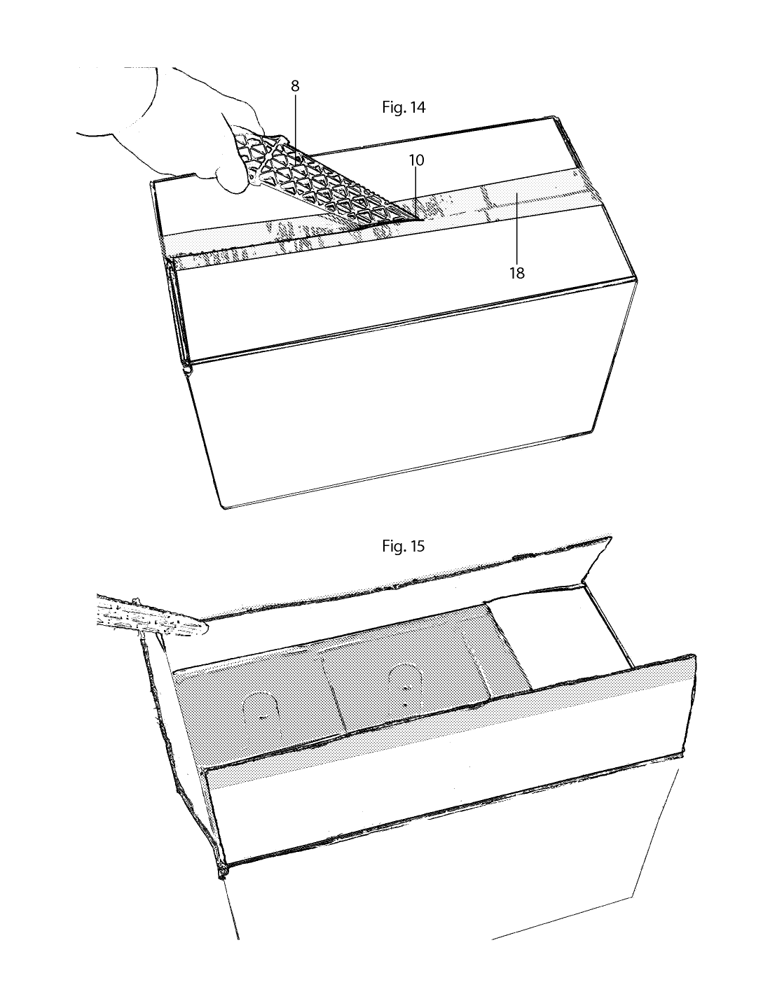

FIG. 11, FIG. 12, FIG. 13 and FIG. 14 illustrate the manner the present invention may be used for opening a box where the flaps have been partially taped shut leaving access for the shaft 8 to enter between the taped flaps and the side surfaces they are taped to. For this type of a taped carton, the shaft 8 is inserted between the two surfaces, and then by either pushing, pulling or sliding the tape splitting teeth 10 up or down right or left against and through the tape 18, and if necessary given a slight twist, to split the tape 18 allowing the box to be opened as shown in FIG. 15.

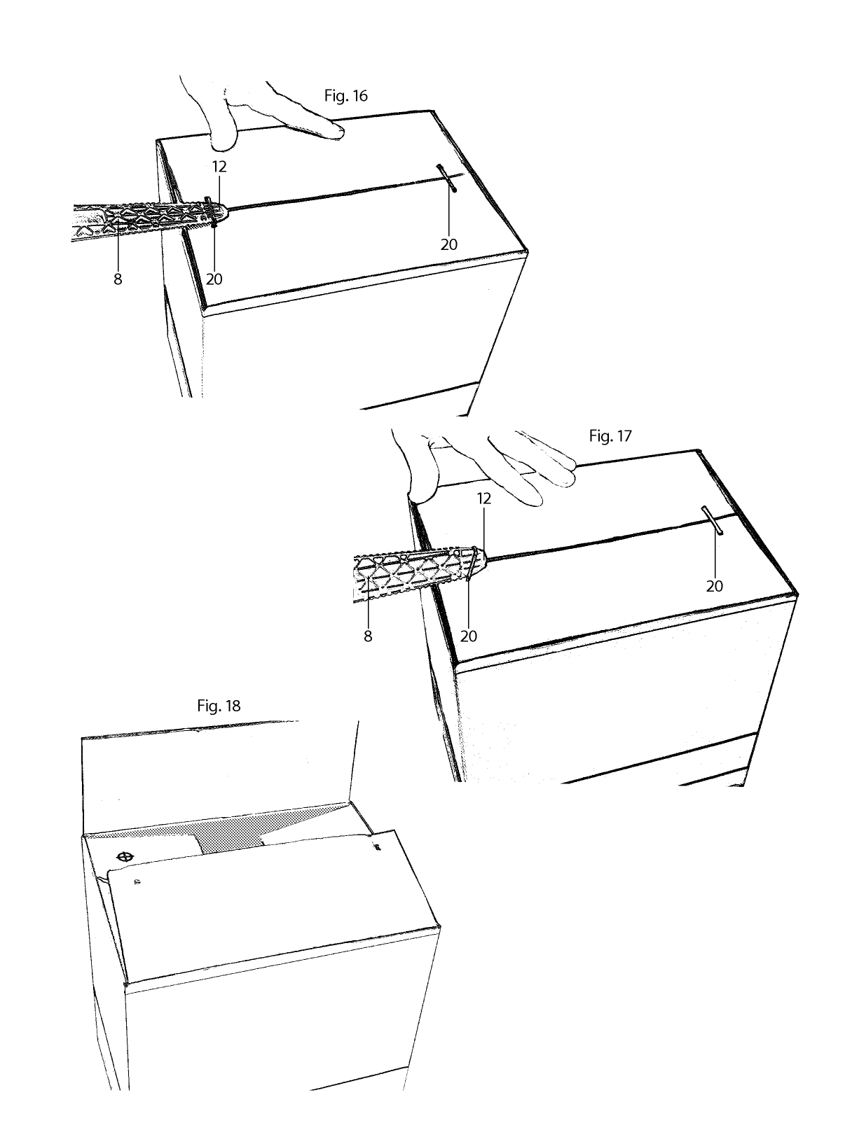

FIG. 16 and FIG. 17 illustrate the manner the present invention may be used for opening a box that has been stapled shut with carton staples. The tip 12 of the shaft 8 is inserted under the staples 20 to be removed, and then by a twisting motion of the box opener, staples 20 are easily removed. FIG. 18 shows the open condition of the box after the staples have been removed, by a box opener of the present invention, in the manner described above.

In further detail, still referring to the invention of FIG. 1, FIG. 2 and FIG. 3, the handle 2 is ergonomic in design to maximize productivity by minimizing operator hand fatigue and discomfort during repetitive use.

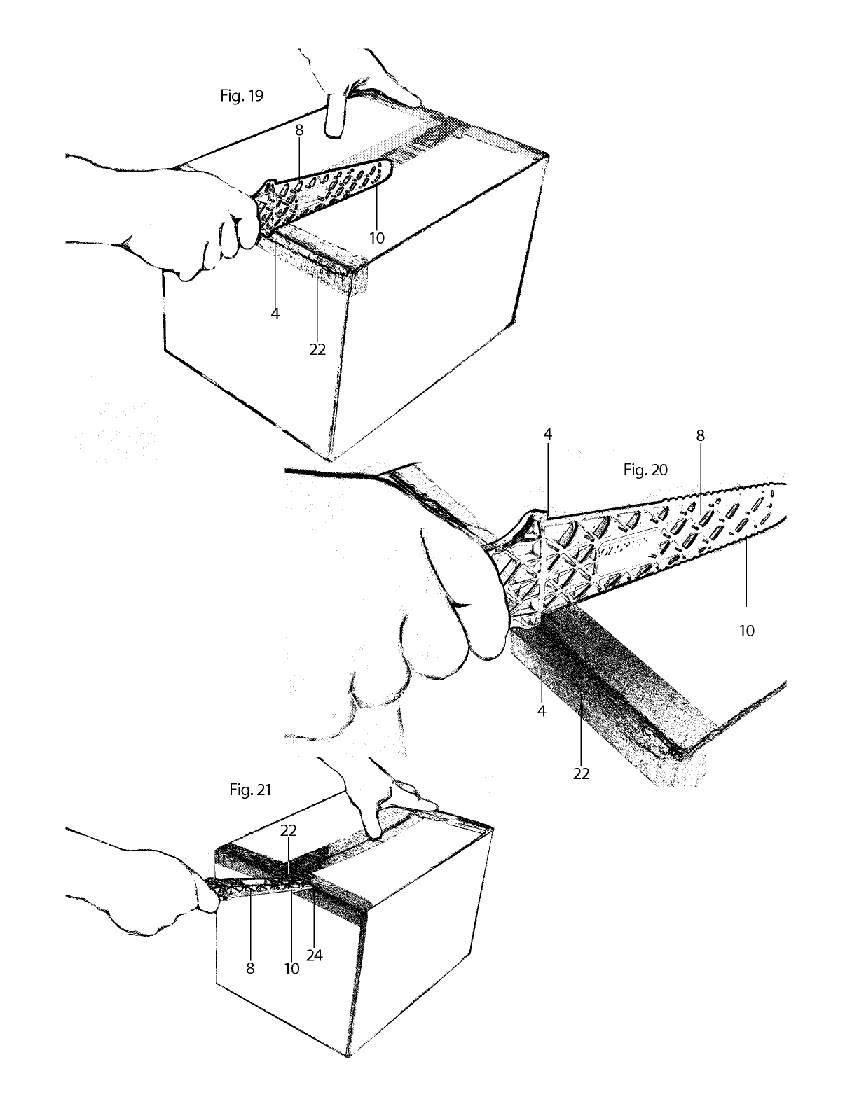

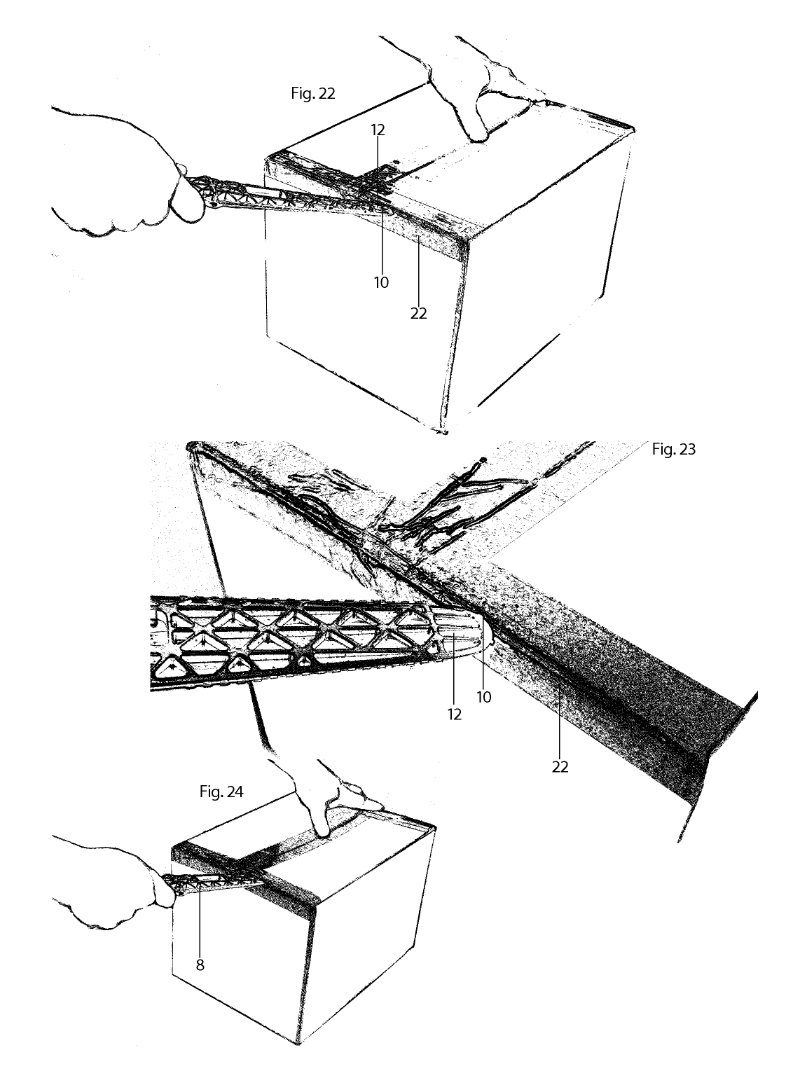

The puncture points are used for puncturing sealing tapes which have sealed the entire flaps of a box, as shown in FIG. 19 and FIG. 20, by pushing a puncture point against the tape. This is accomplished by holding the handle of the invention in one hand and then forcibly pushing the puncture point 4 located on the grip guard collar into the sealing tape 22 to be punctured. Once the tape 22 is punctured an access point 24 is created to allow the shaft 8 to enter as shown in FIG. 21, allowing the tape splitting teeth 10 on the edges to complete the open condition of the box. The tape splitting teeth 10 split open the tape by inserting the shaft 8 into the access point 24, created by the puncture point 4, and between the taped surfaces, and then by either pushing, pulling or sliding the tape splitting teeth 10 up or down right or left against and through the tape as shown in FIG. 11, FIG. 12, FIG. 13, and FIG. 14. The tape splitting teeth 10 on the tip 12 of the invention can also be used to split the tape open by pushing the teeth 10 on the tip 12 against and into the tape 22 as shown in FIG. 22 and FIG. 23 splitting it open creating an access point allowing easy access for the shaft 8 to be inserted as shown in FIG. 24 to complete the open condition of the box as described above.

The manufacturing details of the invention as shown in FIG. 1 and FIG. 2 and FIG. 3 is that the box opener may be made with any resin capable of being injection molded like, but not limited to, High Impact Polystyrene, High Density Polyethylene, Nylon, Acrylonitrile Butadiene Styrene, Acetal and Polypropylene. The resins can be 100% virgin material or 100% recycled material or any combination of virgin and recycled materials. The resins can also include additives like, but not limited to, Fillers, Extenders, Flame Retardants, Fragrances, Heat Stabilizers, Impact Modifiers, Pigments and Reinforcements. The box opener may also have incorporated into it at least one magnet as means for securing it to, but not limited to, warehouse machinery, metallic work tables, fridges and metallic racking.

Although the box opener of the present invention may be formed from several connected parts, the box opener is preferably an integrally-molded, unitary article. The box opener may be injection molded in one-piece from moldable materials such as plastics. Moldable materials may include recyclable materials such as thermoplastics and may include at least in part recycled materials. Preferably, the box opener is formed entirely from recycled plastic

The tape splitting teeth of the box opener of the present invention can also be used to tear, split and puncture plastic film typically used to wrap pallets of goods and plastic shrink wrap typically used to hold together flats or trays of bottled waters, cans of pop etc.

Although the present invention has been described with reference to preferred embodiments, workers skilled in the art will recognize changes may be made in form and detail without departing from the spirit and scope of the invention.

I claim:

1. A one-piece handheld bladeless box opening device comprising:
a) a handle;
b) a shaft; and
c) at least one tape splitter element.

2. The box opener of claim 1 in which the box opener is made from any appropriate material.

3. The preferred box opener of claim 1 is made from plastic.

4. The preferred handle of the box opener in claim 1 is ergonomic.

5. The preferred handle of the box opener in claim 1 has a hole through it.

6. The preferred box opener of claim 1 has a grip guard collar located between the handle and the shaft.

7. The preferred grip guard collar of claim 6 has at least one puncture point extending forward.

8. The preferred shaft of the box opener of claim 1 is wedge shaped.

9. The preferred shaft of the box opener of claim 1 has a plurality of tape splitter teeth located bilaterally on the edges and tip.

10. The preferred tip of the shaft of the box opener of claim 1 is the thinnest part of the shaft.

11. The preferred shaft of the box opener of claim 1 has a name plate advertising space.
